(19) United States
(12) Patent Application Publication
(10) Pub. No.: US 2015/0222546 A1
(43) Pub. Date: Aug. 6, 2015

(54) Load Balancing in Communication Systems

(71) Applicants: Vinh Van Phan, Oulu (FI); Jian Feng Qiang, Beijing (CN); Simone Redana, Munich (DE)

(72) Inventors: Vinh Van Phan, Oulu (FI); Jian Feng Qiang, Beijing (CN); Simone Redana, Munich (DE)

(21) Appl. No.: 14/427,020

(22) PCT Filed: Sep. 12, 2012
(86) PCT No.: PCT/EP2012/067800

§ 371 Date: Mar. 10, 2015

(51) Int. Cl. H04L 12/803; H04L 12/911

(52) U.S. Cl. CPC H04L 47/125; H04L 47/783

(57) ABSTRACT

Apparatus and method for communication are provided. The solution includes controlling communication links to a set of user equipment; transmitting a request for information related to a temporary resource commitment to one or more nodes of a communication system; receiving information related to a temporary resource commitment from the one or more nodes; assigning the communication links to more than one groups based on the received information and the properties of the communication links, each group including one or more communication links and transferring groups including the communication links to the one or more nodes based on the assignment.

### FIELD

The exemplary and non-limiting embodiments of the invention relate generally to wireless communication systems. Embodiments of the invention relate especially to apparatuses, methods, systems, computer programs, computer program products and computer-readable media. an apparatus and a method in communication networks.

### BACKGROUND

The following description of background art may include insights, discoveries, understandings or disclosures, or associations together with disclosures not known to the relevant art prior to the present invention but provided by the invention. Some of such contributions of the invention may be specifically pointed out below, whereas other such contributions of the invention will be apparent from their context.

In the long term evolution advanced (LTE-Advanced) communication system, which is currently being developed, the concept of authorized shared access (ASA) has been under consideration. The ASA allows new user equipment (UE) to access already licensed spectrum with the obligation to protect the incumbent (primary) user. The access may be carried out by using cognitive radio capabilities, such as geolocation databases complemented, if required, by sensing.

There may be situations when some or all UEs of an ASA cell need to handover (HO) to the neighbour cells. This results to a large number of handover which must be realized almost simultaneously. The realization of the handovers may be problematic from the network point of view. The same kind of load balancing problem may also occur in other situations, such as ASA cell evacuation, on-the-fly cell switching-off/cell split/cell merger for energy-saving or performance optimization, site-failure recovery, or handovers of large moving network sub-systems or entities such as moving relays of high speed trains.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to a more detailed description that is presented later.

According to an aspect of the present invention, there is provided an apparatus, in a first communication system, comprising: at least one processor; and at least one memory including computer program code, the at least one memory and the computer program code configured to, with the at least one processor, cause the apparatus at least to perform: control communication links to a set of user equipment; cause the transmission of a request for information related to a temporary resource commitment to one or more nodes of a communication system; control the reception of information related to a temporary resource commitment from the one or more nodes; assign the communication links to more than one groups based on the received information and the properties of the communication links, each group comprising one or more communication links; control the transfer of groups comprising the communication links to the one or more nodes based on the assignment.

According to an aspect of the present invention, there is provided an apparatus in a first communication system, comprising: at least one processor; and at least one memory including computer program code, the at least one memory and the computer program code configured to, with the at least one processor, cause the apparatus at least to perform: control resources and channels related to communication links between the apparatus and user equipment; control the reception of a request from a neighbouring node for information related to a temporary resource commitment the apparatus may provide; determine on the basis of the request information related to resources and channels related to communication links for the temporary resource commitment the apparatus can provide to the neighbouring node; cause the transmission of a response to the request to the neighbouring node, the response comprising determined information; control the transfer of one or more groups comprising one or more communication links from the neighbouring node to the apparatus.

According to another aspect of the present invention, there is provided a method in a communication system, comprising: controlling communication links to a set of user equipment; causing the transmission of a request for information related to a temporary resource commitment to one or more nodes of a communication system; controlling the reception of information related to a temporary resource commitment from the one or more nodes; assigning the communication links to more than one groups based on the received information and the properties of the communication links, each group comprising one or more communication links; controlling the transfer of groups comprising the communication links to the one or more nodes based on the assignment.

According to yet another aspect of the present invention, there is provided a method in a communication system, comprising: controlling resources and channels related to communication links between the apparatus and user equipment; controlling the reception of a request from a neighbouring node for information related to a temporary resource commitment the apparatus may provide; determining on the basis of the request information related to resources and channels related to communication links for the temporary resource commitment the apparatus can provide to the neighbouring node; causing the transmission of a response to the request to the neighbouring node, the response comprising determined information; controlling the transfer of one or more groups comprising one or more communication links from the neighbouring node to the apparatus.

### LIST OF DRAWINGS

Embodiments of the present invention are described below, by way of example only, with reference to the accompanying drawings, in which

FIG. 1 illustrates an example of a communication environment;

FIG. 2 illustrates an example of an apparatus applying embodiments of the invention;

FIGS. 3A and 3B are flowcharts illustrating embodiments of the invention; and

FIG. 4 is a flowchart illustrating an embodiment.

### DESCRIPTION OF SOME EMBODIMENTS

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may also contain also features, structures, units, modules etc. that have not been specifically mentioned.

Embodiments are applicable to any base station, user equipment (UE), server, corresponding component, and/or to any communication system or any combination of different communication systems that support required functionalities.

The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, embodiments.

Many different radio protocols to be used in communications systems exist. Some examples of different communication systems are the universal mobile telecommunications system (UMTS) radio access network (UTRAN or E-UTRAN), long term evolution (LTE®, known also as E-UTRA), long term evolution advanced (LTE-A®), Wireless Local Area Network (WLAN) based on IEEE 802.11 standard, worldwide interoperability for microwave access (WiMAX), Bluetooth®, personal communications services (PCS) and systems using ultra-wideband (UWB) technology. IEEE refers to the Institute of Electrical and Electronics Engineers. LTE and LTE-A are developed by the Third Generation Partnership Project 3GPP.

In the following, different exemplifying embodiments will be described using, as an example of an access architecture to which the embodiments may be applied, a radio access architecture based on long term evolution advanced (LTE Advanced, LTE-A), that is based on orthogonal frequency multiplexed access (OFDMA) in a downlink and a single-carrier frequency-division multiple access (SC-FDMA) in an uplink, without restricting the embodiments to such an architecture, however. It is obvious for a person skilled in the art that the embodiments may also be applied to other kinds of communications networks having suitable means by adjusting parameters and procedures appropriately.

In the LTE-Advanced, the concept of authorized shared access (ASA) has been under consideration. The ASA allows new users to access already licensed spectrum with the obligation to protect the incumbent (primary) user. For example, the ASA allows international mobile telecommunications (IMT) service to access the bands that are under-utilised by existing primary uses, especially to bands that have been allocated to mobile but not made available for mobile use through current regulatory means. The access may be carried out by using cognitive radio capabilities, such as geolocation databases complemented, if required, by sensing. In general, the ASA is neither similar to exclusive licensing nor license-exempt but has few commonalities with licensing-light. According to the ASA concept, a secondary usage is possible, but the operator needs to evacuate its ASA spectrum for providing service to primary ASA users, if required. In principle, for the cell evacuation or clearance, fast and robust handovers to neighbouring cells are required. Thus, an abrupt need for the addition of random access channel (RACH) resources may take place. Additionally, an effective and fast load-balancing procedure may be required.

It should be appreciated that embodiments described herein may be applied, in addition to the ASA, to load balancing in general, such as on-the-fly cell switching-off for energy-saving or performance optimization, site-failure recovery, etc. Embodiments are also suitable for intra/inter radio access technology (RAT) handovers.

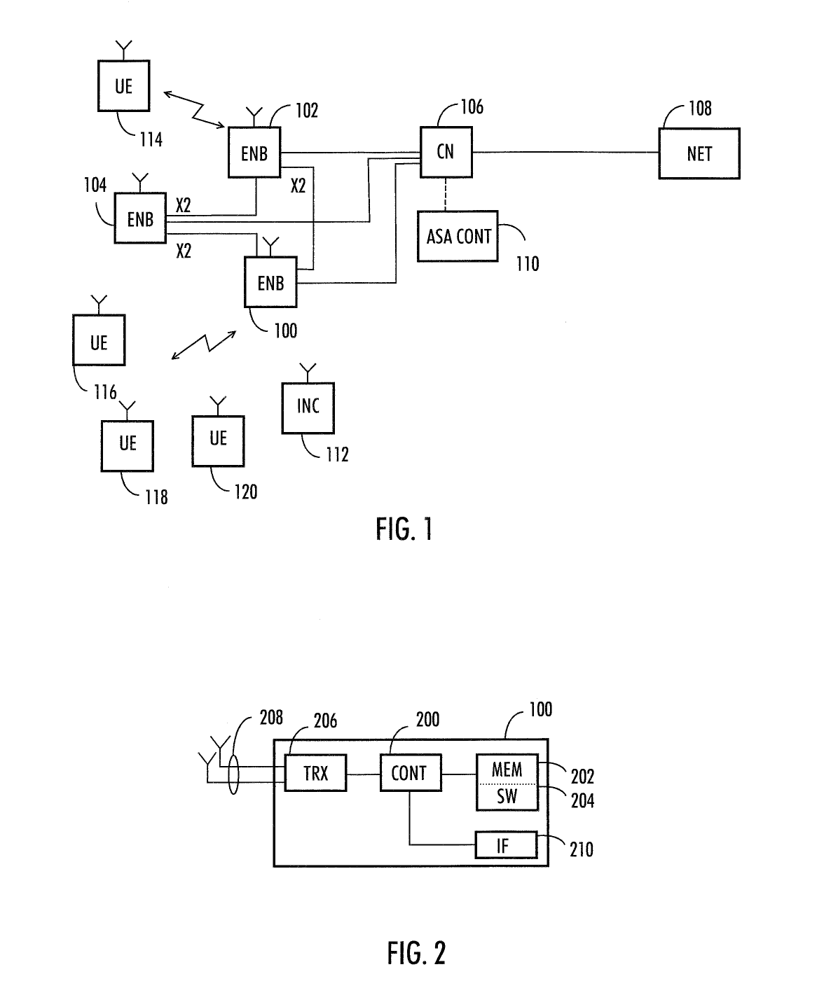

FIG. 1 illustrates a simplified view of a communication environment only showing some elements and functional entities, all being logical units whose implementation may differ from what is shown. The connections shown in FIG. 1 are logical connections; the actual physical connections may be different. It is apparent to a person skilled in the art that the systems also comprise other functions and structures. It should be appreciated that the functions, structures, elements and the protocols used in or for communication are irrelevant to the actual invention. Therefore, they need not to be discussed in more detail here.

In the example of FIG. 1, a radio system based on long term evolution advanced (LTE Advanced, LTE-A) network elements is shown. However, the embodiments described in these examples are not limited to the LTE-A radio systems but can also be implemented in other radio systems.

FIG. 1 shows eNodeBs 100, 102 and 104 connected to core network CN 106 of a communication system. The eNodeBs are connected to each other over an X2 interface.

The eNodeBs 100, 102, 104 that may also be called base stations of the radio system may host the functions for Radio Resource Management: Radio Bearer Control, Radio Admission Control, Connection Mobility Control, Dynamic Resource Allocation (scheduling). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc. The MME (not shown) is responsible for the overall user terminal control in mobility, session/call and state management with assistance of the eNodeBs through which the user terminals connect to the network.

The communication system is also able to communicate with other networks, such as a public switched telephone network or the Internet 108. The communication network may also be able to support the usage of cloud services. It should be appreciated that eNodeBs or their functionalities may be implemented by using any node, host, server or access point etc. entity suitable for such a usage.

The user equipment UE (also called user device, user terminal, terminal device, etc.) illustrate one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device.

The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Further, although the apparatuses have been depicted as single entities, different units, processors and/or memory units (not all shown in FIG. 1) may be implemented.

The communication system further comprises an ASA controller 110 configured to control ASA based operations within the system. In the example situation of FIG. 1, there is licenced spectrum available in the area. The licensed spectrum may be in incumbent use 112. The ASA controller 110 receives from administration or regulation networks information where and when ASA spectrum is available. The information may be dynamic, i.e. it may change with time.

In the example of FIG. 1, UE 114 is connected to the eNodeB 102 using spectrum allocated to the communication system. UEs 116, 118, 120 are connected to eNodeB 100 using ASA spectrum allocated to the eNodeB by the ASA controller.

It is obvious for a person skilled in the art that the depicted system is only an example of a part of a radio access system and in practise, the system may comprise a plurality of eNodeBs, the user device may have an access to a plurality of radio cells and the system may comprise also other apparatuses, such as physical layer relay nodes or other network elements, etc. At least one of the NodeBs or eNodeBs may be a Home eNodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometres, or smaller cells such as micro-, femto- or picocells. The eNodeBs of FIG. 1 may provide any kind of these cells. A cellular radio system may be implemented as a multilayer network including several kinds of cells. Typically, in multilayer networks, one node provides one kind of a cell or cells, and thus a plurality of eNodeBs are required to provide such a network structure.

Recently for fulfilling the need for improving the deployment and performance of communication systems, the concept of “plug-and-play” eNodeBs has been introduced. Typically, a network which is able to use “plug-and-play” eNode Bs, includes, in addition to Home eNodeBs HNBs, a home node B gateway, or HNB-GW (not shown in FIG. 1). A HNB Gateway (HNB-GW), which is typically installed within an operator's network may aggregate traffic from a large number of HNBs back to a core network.100 and an MME 102.

FIG. 2 illustrates an embodiment. The figure illustrates a simplified example of a device in which embodiments of the invention may be applied. In some embodiments, the device may be a base station or eNodeB or a part of an eNodeB communicating with a set of UEs.

It should be understood that the apparatus is depicted herein as an example illustrating some embodiments. It is apparent to a person skilled in the art that the device may also comprise other functions and/or structures and not all described functions and structures are required. Although the device has been depicted as one entity, different modules and memory may be implemented in one or more physical or logical entities.

The device of the example includes a control circuitry 200 configured to control at least part of the operation of the device.

The device may comprise a memory 202 for storing data. Furthermore the memory may store software 204 executable by the control circuitry 200. The memory may be integrated in the control circuitry.

The device comprises a transceiver 206. The transceiver is operationally connected to the control circuitry 200. It may be connected to an antenna arrangement 208 comprising one more antenna elements or antennas.

The software 204 may comprise a computer program comprising program code means adapted to cause the control circuitry 200 of the device to control a transceiver 206.

The device may further comprise an interface 210 operationally connected to the control circuitry 200. The interface may connect the apparatus to other respective apparatuses such as eNodeB via X2 interface or to the core network.

The control circuitry 200 is configured to execute one or more applications. The applications may be stored in the memory 202.

The ASA concept is a framework to share spectrum between limited numbers of authorized ASA users. Under this concept, the primary user(s) (e.g. the “incumbent(s)”) could exclusively share its spectrum (the ASA spectrum) with one or several operators of communication systems. In other words, operators could exclusively use the spectrum band when and where no primary service scheduled on the band. The operator needs to evacuate the spectrum band if the primary service requires it.

One of the key challenges of ASA cell evacuation is how to ensure fast and robust handover (HO) of as many UEs of the ASA cell in question to neighbour cells as possible. Thus, radio resources are needed when handing over so many connected UEs to the neighbour cells. Capacity could be available in the target cells but if the handovers are initiated only towards few of the target cells the available capacity is not exploited and many handovers may fail. Radio resources are limited factors in the target cells. Moreover, how to configure a proper Physical Downlink Control Channel (PDCCH) resource in legacy LTE system and how to estimate/configure the proper PDCCH & evolved PDCCH (ePDCCH) resources when in-bound handover UEs rush into the target cell are important issues.

In an embodiment, a novel quota based load balance scheme in quick massive handover scenarios regarding large group of UEs or sub-network system or entities such as mobile relays) is proposed. In general, the scheme is applicable in many scenarios, such as ASA cell evacuation, intra-RAT/inter-RAT load balance, etc. The scheme is composed of a QUOTA REQUEST messages from a source cell towards neighbour cells (target cells) and QUOTA RESPONSE messages from neighbouring cells. The request and response messages comprise information related to a temporary resource commitment between the cells. The quota can be used by the source cell to group/categorize different UEs of the source cell for massive handover preparation and execution. In an embodiment, the proposed solution aims at facilitating and optimizing both mobility load balancing and handover performance.

The quota, which may be considered as a designated commitment from the target cell instead of a regular resource status report provided by target cell upon request of the source cell, can be used by the source cell to group, categorize and/or select different UEs in the source cell for upcoming handovers. The quota may be used to count the number of out-bound handover UEs to different target cells.

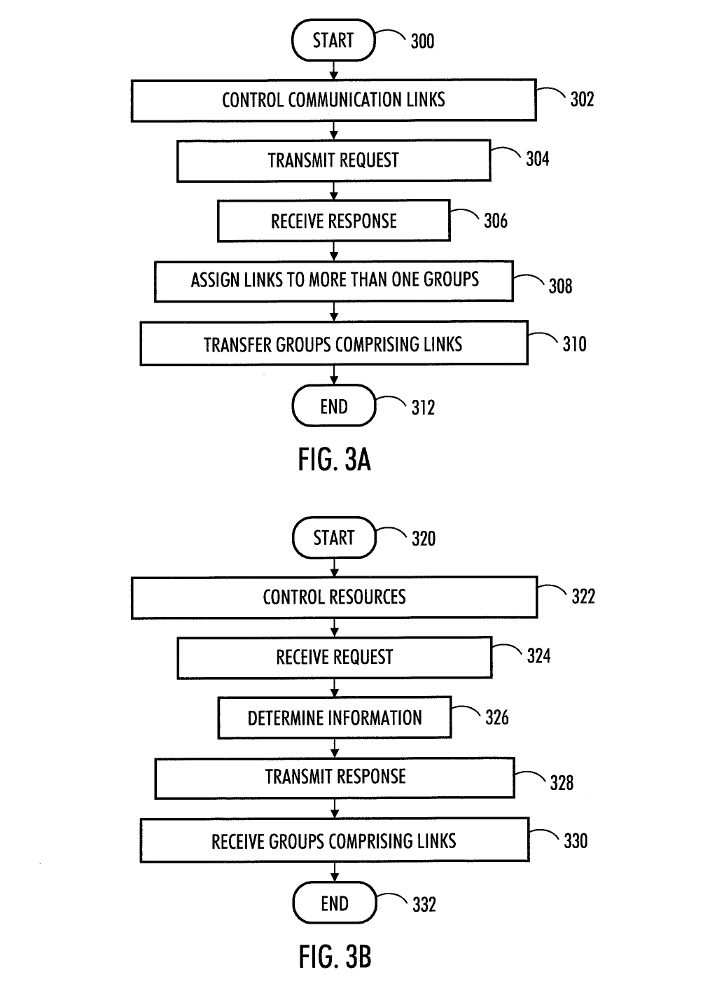

FIG. 3A is a flowchart illustrating an embodiment of the invention. The embodiment starts at step 300. Here an example situation is assumed where the UEs served by eNodeB 100 need to be transferred to other eNodeBs of the communication system as the ASA spectrum is need by the primary user 112.

In step 302, the eNodeB 100 controls communication links of the UEs connected to it.

In step 304, the control circuitry of eNodeB causes the transmission of a request for information related to a temporary resource commitment to one or more nodes of a communication system. The nodes in this example may be 102, 104 and any other nearby node not shown in FIG. 1.

In step 306, the control circuitry of eNodeB controls the reception of information related to a temporary resource commitment from the one or more nodes.

In step 308, the control circuitry of eNodeB assigns the communication links to more than one groups based on the received information and the properties of the communication links, each group comprising one or more communication links.

In step 310, the control circuitry of eNodeB controls the transfer of groups comprising the communication links to the one or more nodes based on the assignment.

The process ends in step 312.

FIG. 3B is another flowchart illustrating an embodiment of the invention. The embodiment starts at step 320. Here is the same example situation as above where the UEs served by eNodeB 100 need to be transferred to other eNodeBs of the communication system as the ASA spectrum is need by the primary user 112. The operation of a target node is illustrated in this example.

In step 322, an eNodeB controls resources and channels related to communication links between the eNodeB and user equipment. The eNodeB thus serves a cell.

In step 324, the eNodeB controls the reception of a request from a neighbouring node for information related to a temporary resource commitment the eNodeBmay provide.

In step 326, the eNodeB is configured to determine on the basis of the request information related to resources and channels related to communication links for the temporary resource commitment the eNodeB can provide to the neighbouring node.

In step 328, the eNodeB transmits a response to the request to the neighbouring node, the response comprising determined information.

In step 330, the eNodeB controls the transfer of one or more groups comprising one or more communication links from the neighbouring node to the eNodeB. Thus, one or more groups comprising one or more communication links perform handovers to the eNodeB from the neighbouring node.

The process ends in step 332.

In an embodiment, a load balancing operation may be triggered by either an ASA controller or by a source node (eNodeB) of the ASA cell in question. An ASA controller may locate in a core network, it may be a stand-alone device or it may be provided as a cloud service. Typically, the ASA controller is a part of an operator management network.

In an embodiment, a quota scheme for load balance in massive handover burst is provided. The scheme may utilise QUOTA REQUEST messages from source node towards neighbour cells and QUOTA RESPONSE messages from neighbouring cells. The QUOTA REQUEST message comprises information related to a temporary resource commitment

A target node may, upon receiving a QUOTA REQUEST notification, determine a quota specifying resources it can allocate for communications links currently served by the source node and indicate that to the source node over an interface between the source node and the target node, such as an X2 interface. The quota may include the maximum number of UEs it is able to provide service for, maximum total or aggregated guaranteed bit rate and/or a timing parameter (quota life-time) specifying the period of time the quota is valid. This timing parameter may be indicated as a time stamp, system frame number or sub-frame the message is sent over an interface between the source node and the target node, such as X2, or duration.

The quota may be regular quota exchange or ad hoc quota by event trigger (such as a handover burst). Signalling indication or some typical measurement parameters can trigger the event. The quota could be multi-ranks in the case of multi-level emergency or priority functions or services. For instance, some resource quota for low priority UE or UE group, other resource quota for high priority UE or UE group or large moving network system or entity such as moving relays.

The quota may comprise multiple parameters or a single parameter. A single parameter may include the number of UEs a cell may receive. A multi-parameter quota may include parameters such as total Physical Resource Block PRB availability, ePDCCH capacity availability, interference limit, Connection Admission Control CAC and UE number, for example.

The quota could be hard constraints or soft or both during the validity life time of the quota or certain parts thereof. For example, a soft quota may be provided with some variable range or probability of validity or some other options. Furthermore, the validity life time of the quota may be given with a single time interval or multiple consecutive time intervals which may also be modifiable (shorten, extend, split, merge or invalidate by providing target node whether upon request from source node or not). The option of multiple consecutive time intervals may be introduced particularly for soft quota or option including both soft and hard quotas. For example, the quota may be provided with two consecutive time periods: T1, T2, where the quota is hard over T1 and then soft over T2. An alternative option is to have a quota over T2 which is different from the quota over T1.

In an embodiment, UE prioritization, grouping and differentiation based quota scheme in massive handover scenarios is proposed. Prioritization may comprise dividing the UEs into a low priority UE group, a high priority UE group and/or a special moving network entity group. For example, the highest priority UEs may be configured to perform a legacy individual UE handover procedure prior other UEs. Then, a combined handover of number of the rest of the UEs may be performed. Thus, in handover request or quota request we can have two separate parts: one is for “low priority group load” and the other is for “individual UE”. The target node may grant quota to high priority UEs and low priority UEs (group), respectively. The quota allocation may include some UE prioritization flag(s) or UE group ID(s) indicating which option(s) or group(s) are supported in the target node or, i.e., source may take for granted in upcoming massive handover request. This may be further enhanced with some “cost” driven UE classification and selection.

The quota allocation may further indicate temporary or current serving capabilities and priorities of the quota-providing target node as well. The target node or eNodeB may have such capabilities and serving priorities like UE but more complex and collective, and these may vary in time depending on processing and service load of target node from both serving network and eNodeB equipment point of view.

In addition to QUOTA REQUEST and QUOTA RESPONSE messages there may be additional messages and procedures related to quota signalling and control over the X2 interface between eNodeBs of two neighbouring cells. These are optional and may happen during the valid life-time of the quota provided by the initial QUOTA REQUEST-QUOTA RESPONSE.

The source eNodeB which received the quota from a target eNodeB may send a QUOTA RELEASE or QUOTA MODIFICATION message to the target eNodeB to request a release or a modification of the provided quota. This may affect a certain part or entire of the quota, e.g., to shorten or extend the valid life time of the current quota, to change or release some allocation or parameter of the quota, etc.

The target eNodeB which provided a quota to a neighbouring-cell source eNodeB may send a QUOTA INDICATION/MODIFICATION/RELEASE message to that source eNodeB to reassure, change or release a part or entire of the provided quota it provided.

When a target node determines a response to a QUOTA REQUEST message, it may be configured to collect information on affordable resource capacity and configuration, such as ePDCCH resources. Information on UE or service group based radio resource (such as PRB, PDCCH) usage parameter may be collected as well.

PDCCH capacity may be one of the bottlenecks of an LTE system. When determining a QUOTA RESPONSE it may be taken into account. In an embodiment, a node can allocate new ePDCCH resource by PRB(s) per a sub frame. So a new physical layer measurement, regarding ePDCCH usage and or availability may be defined and included in the quota. For the ePDCCH capacity prediction in the target node, the connecting UEs consume some ePDCCH resource. The average ratio to the upper limit may be determined in target node and the remained ePDCCH resource can be included in the quota and provided to the source node.

In a handover burst, the PDCCH/ePDCCH capacity prediction of the target node may be one of admission control factors. In an embodiment, it may be evaluated how many PDCCH/ePDCCH resource are needed in a target node. In the source node, the PDCCH/ePDCCH resource average requirement may be measured per UE or UE group. The source node can determine some specific UEs handover to a specific target node based on a PDCCH/ePDCCH quota.

Some special considerations may be determined for the PDCCH/ePDCCH measurement and quota allocation. It may be determined which UEs and which nodes cells support ePDCCH configuration. Those which do not support ePDCCH use only legacy PDCCH resource. It may be determined whether dynamic service or semi-persistence service for the UE may be used, i.e. whether dynamic service request ePDCCH resource may be used instead of semi-persistence scheduling RRC configuration.

The locations of the UEs within a cell may be taken into account when determining resources. For example, a cell edge UE may require Hybrid automatic repeat request HARQ retransmissions compared to a nearby UE. This leads to a need for more PDCCH resource for payload data. On the other hand, poor PDCCH BER performance needs more PDCCH resource at cell edge.

Multi-antenna code transmission by the UE (code-word based PDCCH/ePDCCH requirement) may be taken into account. For instance, 2-code MIMO UE consumes twice the PDCCH resource compared with a non-MIMO UE.

In an embodiment, the proposed QUOTA REQUEST and QUOTA RESPONSE procedures may be introduced as new network signalling procedures. In LTE based systems the signalling occurs over X2 interface. In an embodiment in LTE based networks, existing Mobility Load Balancing (MLB) procedures of LTE/LTE-A and messages may be reused and extended with new elements to incorporate the proposed quota scheme. The quota procedure is likely on the need basis of a source node with once-off request and some specific valid life-time. However, the option that a source node asks for a periodical quota indication from the neighbouring cells may be introduced as well.

Based on the quota allocations from neighbouring nodes as potential target nodes in handover, source node may be able to select and distribute handovers of UEs to target nodes in fast and reassuring fashion. The decision making and allocation should be rather straightforward and quick at both the source node and the target node. In the following, some proposals are made to facilitate necessary decision-making operation prior to initiating massive handover request: how to prioritize and select UEs and corresponding target cells for distributing massive handover in cell evacuation.

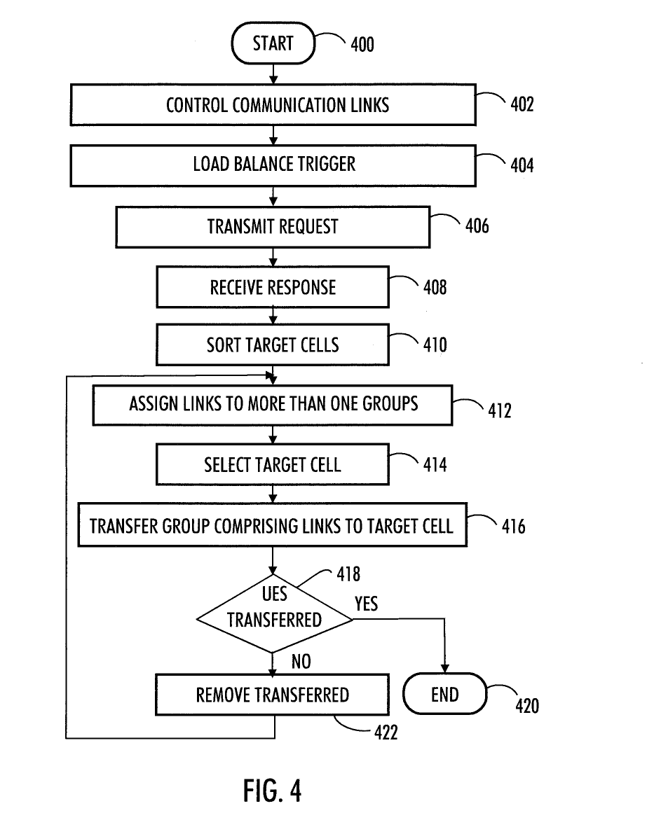

In an embodiment, target nodes are involved in the process as little as possible and UEs are transferred to a smallest number of target nodes as possible. The nodes are determined by the source node based on “quotas” provided by all potential target nodes beforehand. The procedure is illustrated in FIG. 4.

FIG. 4 is another flowchart illustrating an embodiment. The embodiment starts at step 400.

In step 402, the eNodeB 100 controls communication links of the UEs connected to it.

In step 404, a load balance operation is triggered. In an embodiment, a load balancing operation may be triggered by either an ASA controller or by a source node (eNodeB) of the ASA cell in question.

In step 406, the control circuitry of eNodeB is configured to cause the transmission of a request for information related to a temporary resource commitment to one or more nodes of a communication system.

In step 408, the control circuitry of eNodeB controls the reception of information related to a temporary resource commitment from the one or more nodes. The information related to a temporary resource commitment is denotes as quota below.

In step 410, the control circuitry of eNodeB may sort target nodes based on quotas provided by the nodes to obtain a target node list.

In step 412, the control circuitry of eNodeB is configured to assign communication links of UEs to UE groups, referred to a group of individual UEs having the same preferred attributes such as quality of service QoS or bearer service requirements or some physical attributes such as same timing advance information. Communication links of individual UEs or UE groups are further assigned to individual target nodes based on suitability (service continuity is reassured to certain extent if UE is handed over to the assigned target node).

In step 414, the control circuitry of eNodeB is configured to select a target node which is suitable for most UEs (has the most UEs assigned) to initiate a massive handover.

In step 416, the control circuitry of eNodeB assigns the communication links to more than one groups based on the received information and the properties of the communication links, each group comprising one or more communication links.

In step 418 it is checked whether communications links of all UEs have been transferred. If yes, the process ends in 420.

If not, transferred UEs and their target nodes are removed from UE list and target node list in step 422. Then, the process continues from step 412.

In another embodiment, the eNodeB is configured to distribute the UE groups comprising the communication links as evenly as possible to the target nodes.

A suitable sophisticated cost function optimization may be used for making decisions in the above embodiments.

The steps and related functions described in the above and attached figures are in no absolute chronological order, and some of the steps may be performed simultaneously or in an order differing from the given one. Other functions can also be executed between the steps or within the steps. Some of the steps can also be left out or replaced with a corresponding step.

The apparatuses or controllers able to perform the above-described steps may be implemented as an electronic digital computer, or a circuitry which may comprise a working memory (RAM), a central processing unit (CPU), and a system clock. The CPU may comprise a set of registers, an arithmetic logic unit, and a controller. The controller or the circuitry is controlled by a sequence of program instructions transferred to the CPU from the RAM. The controller may contain a number of microinstructions for basic operations. The implementation of microinstructions may vary depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

An embodiment provides a computer program embodied on a distribution medium, comprising program instructions which, when loaded into an electronic apparatus, are configured to control the apparatus to execute the embodiments described above.

The computer program may be in source code form, object code form, or in some intermediate form, and it may be stored in some sort of carrier, which may be any entity or device capable of carrying the program. Such carriers include a record medium, computer memory, read-only memory, and a software distribution package, for example. Depending on the processing power needed, the computer program may be executed in a single electronic digital computer or it may be distributed amongst a number of computers.

The apparatus may also be implemented as one or more integrated circuits, such as application-specific integrated circuits ASIC. Other hardware embodiments are also feasible, such as a circuit built of separate logic components. A hybrid of these different implementations is also feasible. When selecting the method of implementation, a person skilled in the art will consider the requirements set for the size and power consumption of the apparatus, the necessary processing capacity, production costs, and production volumes, for example.

It will be obvious to a person skilled in the art that, as technology advances, the inventive concept can be implemented in various ways. The invention and its embodiments are not limited to the examples described above but may vary within the scope of the claim.

1. An apparatus in a first communication system, comprising:
at least one processor; and
at least one memory including computer program code, the at least one memory
and the computer program code configured to, with the at least one processor, cause the apparatus at least to perform:
control communication links to a set of user equipment;
cause the transmission of a request for information related to a temporary resource commitment to one or more nodes of a communication system;
control the reception of information related to a temporary resource commitment from the one or more nodes;
assign the communication links to more than one groups based on the received information and the properties of the communication links, each group comprising one or more communication links;
control the transfer of groups comprising the communication links to the one or more nodes based on the assignment.

2. The apparatus of claim 1, wherein the received information related to a temporary resource commitment comprises information on the available resources for communication links and channel configurations of the one or more nodes.

3. The apparatus of claim 1, wherein the apparatus is configured to assign the communication links to more than one groups based on the received information and one or more following the properties of the communication links: quality of service, bearer service requirement, timing advance information.

4. The apparatus of claim 1, the apparatus being configured to select a target node for a transfer operation of a group by selecting a node which fulfils property requirements of the majority of the communication links of the group.

5. The apparatus of claim 1, the apparatus being configured to distribute the groups comprising the communication links as evenly as possible to the one or more nodes.

6. The apparatus of claim 1, the apparatus being configured to
determine the priority value of the communication links;
control the handover procedure of the links with highest priority value to one or more nodes;
control the transfer of groups comprising the rest of the communication links to the one or more nodes.

7. The apparatus of claim 1, wherein the request for information related to a temporary resource commitment comprises separate requests for communication links having different priorities or properties.

8. The apparatus of claim 1, wherein the received information related to a temporary resource commitment comprises information at least one of the following: physical resource block availability, physical downlink control channel capacity and availability.

9. The apparatus of claim 1, wherein the received information related to a temporary resource commitment comprises one or more time parameters defining the validity life times of the different parts of the received information.

10. The apparatus of claim 1, the received information related to a temporary resource commitment comprising one or more sections each having a validity time parameter defining the time interval when each section is valid.

11. The apparatus of claim 1, wherein the received information related to a temporary resource commitment comprises either soft or hard parameters values or both.

12. The apparatus of claim 1, wherein the apparatus is configured to request from one or more nodes modification of the information related to a temporary resource commitment.

13. The apparatus of claim 1, wherein the apparatus is configured to request from one or more nodes release at least part of the resources included in the information related to a temporary resource commitment.

14. An apparatus in a first communication system, comprising:
at least one processor; and
at least one memory including computer program code,
the at least one memory and the computer program code configured to, with the at least one processor, cause the apparatus at least to perform:
control resources and channels related to communication links between the apparatus and user equipment;
control the reception of a request from a neighbouring node for information related to a temporary resource commitment the apparatus may provide;
determine on the basis of the request information related to resources and channels related to communication links for the temporary resource commitment the apparatus can provide to the neighbouring node;
cause the transmission of a response to the request to the neighbouring node, the response comprising determined information;
control the transfer of one or more groups comprising one or more communication links from the neighbouring node to the apparatus.

15. The apparatus of claim 14, wherein the information related to a temporary resource commitment comprises separate information for communication links having different priorities or properties.

16. The apparatus of claim 14, wherein the received information related to a temporary resource commitment comprises information at least one of the following: physical resource block availability, physical downlink control channel capacity and availability.

17. The apparatus of claim 14, wherein the received information related to a temporary resource commitment comprises one or more time parameters defining the validity life times of the different parts of the received information.

18. The apparatus of claim 14, the information related to a temporary resource commitment comprising one or more sections each having a validity time parameter defining the time interval when each section is valid.

19. The apparatus of claim 14, wherein the information related to a temporary resource commitment comprises either soft or hard parameters values or both.

20. The apparatus of claim 14, wherein the apparatus is configured to receive from the neighbouring node modification of the information related to a temporary resource commitment.

21. The apparatus of claim 14, wherein the apparatus is configured to receive from the neighbouring node release at least part of the resources included in the information related to a temporary resource commitment.

22-43. (canceled)
